(19) United States
(12) Patent Application Publication
(10) Pub. No.: US 2020/0083771 A1
(43) Pub. Date: Mar. 12, 2020

(54) ELECTRIC WIRE SEGMENT AND STATOR

(71) Applicant: HONDA MOTOR CO., LTD., Tokyo (JP)

(72) Inventors: Keisuke Azusawa, Wako-shi (JP); Ryotaro Kaneko, Wako-shi (JP); Tadao Nishiyama, Wako-shi (JP)

(21) Appl. No.: 16/565,730

(22) Filed: Sep. 10, 2019

(30) Foreign Application Priority Data
Sep. 12, 2018 (JP) 2018-170345

(51) Int. Cl. H02K 3/52; H02K 1/14; H02K 1/16; H02K 3/48; H02K 3/32; H02K 15/00

(52) U.S. Cl. CPC H02K 3/522; H02K 1/148; H02K 15/0056; H02K 3/48; H02K 3/325; H02K 1/16

(57) ABSTRACT

An electric wire segment includes a pair of electric wires, the respective electric wires being arranged in a first direction and having an exposed conductor section in which a conductive material is exposed by having an insulating film peeled off at an end portion thereof, and the exposed conductor sections of the respective electric wires being disposed at positions corresponding to each other, and a coupling section in which the pair of electric wires are coupled to each other at the exposed conductor sections thereof, wherein a peeling amount of the insulating films on facing sides of the exposed conductor sections in which the pair of electric wires face each other is larger than a peeling amount of the insulating films on outward sides of the exposed conductor sections which is opposite to the facing sides in the first direction.

### CROSS-REFERENCE TO RELATED APPLICATION

Priority is claimed on Japanese Patent Application No. 2018-170345, filed Sep. 12, 2018, the content of which is incorporated herein by reference.

### BACKGROUND OF THE INVENTION

### Field of the Invention

The present invention relates to an electric wire segment and a stator.

### Description of Related Art

In the related art, in a rotating electric machine, various technologies for joining tip portions of coils that are inserted into slots of a stator have been proposed.

For example, Japanese Unexamined Patent Application, First Publication No. 2008-154433 discloses a method of joining a pair of exposed conductor sections (a pair of electric wires) constituted by linear sections (exposed conductor sections) of two electric wire segments in an 8-layer 4-row electric wire segment. According to the technology disclosed in Japanese Unexamined Patent Application, First Publication No. 2008-154433, the exposed conductor sections can be joined to each other by directly or indirectly allowing conduction between the exposed conductor sections and the electrodes and thereby performing arc discharge.

### SUMMARY OF THE INVENTION

In the above-mentioned technology disclosed in Japanese Unexamined Patent Application, First Publication No. 2008-154433, in order to minimize damage to an insulating film due to the heat of welding, there is a need to form long exposed conductor sections. However, when long exposed conductor sections are formed, in order to secure insulating properties, it is necessary to increase the distance between a pair of adjacent electric wires having different phases. Accordingly, a width of the coil in the radial direction is increased, which may be a cause of miniaturization being hindered.

Accordingly, in the related art, it is required to provide a small electric wire segment in which a distance between a pair of adjacent electric wires is reduced while securing insulating properties between the electric wires, and a stator including the electric wire segment.

An aspect of the present invention is directed to providing a small electric wire segment in which a distance between a pair of adjacent electric wires is reduced while securing insulating properties between the electric wires, and a stator including the electric wire segment.

(1) An electric wire segment according to an aspect of the present invention includes a pair of electric wires, the respective electric wires being arranged in a first direction and having an exposed conductor section in which a conductive material is exposed by having an insulating film peeled off at an end portion thereof, the conductor exposed sections of the respective electric wires being disposed at positions corresponding to each other; and a coupling section in which the pair of electric wires are coupled to each other at the exposed conductor sections thereof, wherein a peeling amount of the insulating films on facing sides of the exposed conductor sections in which the pair of electric wires face each other is larger than a peeling amount of the insulating films on outward sides of the exposed conductor sections which is opposite to the facing sides in the first direction.

(2) In the aspect of the above-mentioned (1), each of the pair of electric wires may be a rectangular wire, the rectangular wire having two side surfaces provided along the first direction, an outward surface facing outward, and an inner surface facing the facing side.

(3) In the aspect of the above-mentioned (2), the insulating film on the two side surfaces of the electric wire may have an inclined section formed so that an exposed area of the conductive material increases from the outer surface toward the inner surface.

(4) In the aspect of the above-mentioned (2), the insulating film on the two side surfaces of the electric wire may have a step section formed such that an exposed area of the conductive material is increased from the outer surface toward the inner surface.

(5) In the aspect of the above-mentioned (1) to (4), the pair of electric wires may have bent sections that are bent so that the electric wires are separated from each other as the electric wires go toward base ends from tip sides, and an end portion of the insulating film may be formed on the tip side of the electric wire with respect to the bent section.

(6) In the aspect of the above-mentioned (1) to (5), the insulating film may have a vacancy formed therein, and the vacancy may be formed of a hollow capsule.

(7) A stator according to an aspect of the present invention includes a stator core having a plurality of slots; and a coil inserted into the slots and having the electric wire segment according to any one of the above-mentioned (1) to (6).

According to the aspect of the above-mentioned (1), since the peeling amount of the insulating films on the facing sides in the first direction of the exposed conductor sections is larger than the peeling amount of the insulating films on outer sides of the exposed conductor sections in the first direction, contact between the insulating films on the facing sides of the pair of electric wires when the exposed conductor sections are coupled can be minimized. Accordingly, the distance between the pair of coupled electric wires can be reduced. In addition, since the insulating film on the facing sides that can easily be influenced by heat due to welding in comparison with the insulating film on the outer side can be disposed at a position away from the coupling section, damage to the insulating film due to heat during welding can be minimized.

Meanwhile, since a larger amount of the insulating film remains on the outer side facing another pair of electric wires than on the facing sides, even when the distance between the pair of neighboring electric wires is reduced, excellent insulating properties between the pair of electric wires can be maintained. In addition, since there is no need to provide a process for securing a distance between the pair of electric wires during manufacture, the number of manufacturing processes and costs required for the manufacture can be reduced.

Accordingly, it is possible to provide a small electric wire segment having a reduced distance between a pair of neighboring electric wires while securing insulating properties between the electric wires.

According to the aspect of the above-mentioned (2), since the electric wire is constituted by a rectangular wire, the coupling section can be formed on the portions of the pair of electric wires in which the flat inner surfaces face each other. Accordingly, a large area for the coupling section can be secured, and the conductive bodies can be reliably coupled. In addition, it is possible to provide a highly efficient electric wire segment in which a space factor of a coil in the slots is improved.

According to the aspect of the above-mentioned (3), since the insulating film disposed on the side surface of the electric wire has the inclined section, a larger exposed area can be secured for the exposed conductor section disposed on the facing side of the electric wire than for the exposed conductor section on the outward side due to the inclined section. Accordingly, contact between the insulating films on the facing sides when the exposed conductor sections are coupled can be minimized. Accordingly, a distance between the electric wires can be reduced. In addition, since the insulating film is separated from the coupling section, damage to the insulating film due to heat during welding can be minimized.

Moreover, since a larger amount of insulating film on the outward side facing another pair of electric wires remains than of insulating film on the facing side, if the distance between a pair of neighboring electric wires needs to be reduced, excellent insulating properties between the pair of electric wires can be highly maintained. In addition, since the exposed area of the conductive material on the facing sides and the outward sides can be changed simply by cutting off the insulating film obliquely, it is possible to reduce the time and labor required for manufacture thereof.

Accordingly, it is possible to provide a small electric wire segment in which a distance between the electric wires is reduced while securing insulating properties between the pair of neighboring electric wires.

According to the aspect of the above-mentioned (4), since the insulating film disposed at the side surface of the electric wire has the step section, the exposed conductor section on the opposing sides of the electric wire can secure a wider exposed area than that of the exposed conductor section on the outer side using the step section.

Accordingly, contact between the insulating films on the facing sides when the exposed conductor sections are coupled can be minimized. Accordingly, a distance between the electric wires can be reduced. In addition, since the insulating film can be separated from the coupling section, damage to the insulating film due to heat during welding can be minimized.

Meanwhile, since a larger amount of the insulating film is remained on the outer side facing the other pair of electric wires than on the facing sides, even when a distance between the pair of neighboring electric wires is reduced, insulating properties between the pair of electric wires can be highly maintained. In addition, in a torsional bending process of the electric wire segment, since the electric wire segment can be deeply gripped to an extent of a step difference of the step section when the exposed conductor section is chucked, the electric wire segment can be reliably torsionally bent.

Accordingly, it is possible to provide a small electric wire segment in which a distance between the electric wires is reduced while securing insulating properties between the pair of neighboring electric wires.

According to the aspect of the above-mentioned (5), the end portion of the insulating film is present on the tip side of the electric wire with respect to the bent section. Here, since the portions of the pair of neighboring electric wires disposed closer to the tip side of the electric wire compared to the bent section are arranged along the first direction, since the insulating film is present closer to the tip side of the electric wire compared to the bent section, the insulating film can be disposed in the vicinity of the bent section having a small distance to the other pair of electric wires, and insulating properties between the pair of neighboring electric wires can be secured.

Accordingly, a distance between the pair of neighboring electric wires can be reduced, and the electric wire segment can be reduced in size in the arrangement direction.

According to the aspect of the above-mentioned (6), since the insulating film has a vacancy formed therein and has a permittivity lower than that of a material that forms the insulating film, a permittivity of the insulating film due to the vacancy is reduced. Accordingly, when used as the insulating film of the coil used at a high voltage, occurrence of partial discharge in the insulating film can be minimized. Accordingly, an insulating performance of the insulating film can be improved. In addition, since the vacancy is formed of a hollow capsule, since an air layer is present in the insulating film, a thermal resistance of the entire insulating film can be improved. Accordingly, it is possible to provide an insulating film having good thermal resistance and insulating properties and an electric wire segment including the same.

According to the aspect of the above-mentioned (7), it is possible to provide an excellent stator including a small electric wire segment in which a distance between a pair of neighboring electric wires can be reduced while securing insulating properties between the electric wires.

### BRIEF DESCRIPTION OF THE DRAWINGS

FIG. 1 is an external perspective view of a stator according to a first embodiment.

FIG. 2 is an enlarged view of a portion II in FIG. 1.

FIG. 3 is a view of an electric wire segment according to the first embodiment when seen from one side in an axial direction.

FIG. 4 is a view of the electric wire segment according to the first embodiment when seen in a circumferential direction.

FIG. 5 is a view of the electric wire segment according to the first embodiment when seen in a radial direction (a first direction).

FIG. 6 is an enlarged cross-sectional view of an insulating film according to the first embodiment.

FIG. 7 is a view of an electric wire segment according to a second embodiment when seen in a circumferential direction.

### DETAILED DESCRIPTION OF THE INVENTION

Hereinafter, embodiments of the present invention will be described with reference to the accompanying drawings.

### First Embodiment

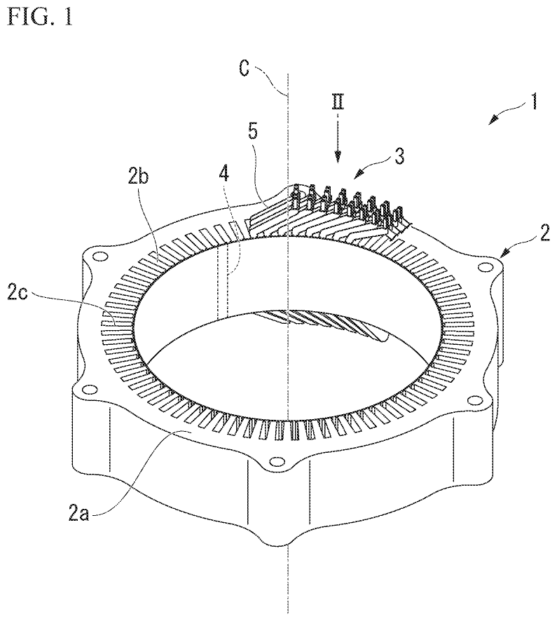

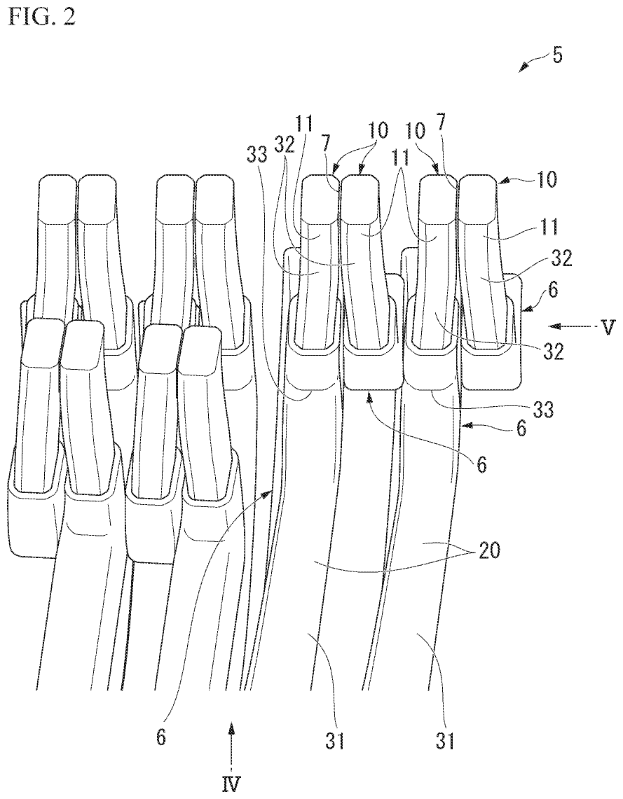

FIG. 1 is an external perspective view of a stator 1. In addition, FIG. 2 is an enlarged view of a portion II in FIG. 1.

The stator 1 includes a stator core 2 and a coil 3. Further, in FIG. 1, a part of the coil 3 will be omitted for convenience of description.

The stator core 2 is formed in an annular shape about an axis C. In the following description, a direction along the axis C may be referred to as an axial direction, a direction perpendicular to the axis C may be referred to as a radial direction, and a direction around the axis C may be referred to as a circumferential direction. The stator core 2 has a core main body 2a and teeth 2b.

The core main body 2a is formed in an annular shape. The teeth 2b protrude from the core main body 2a inward in the radial direction. The plurality of teeth 2b are formed in the circumferential direction. Slots 2c are provided between the teeth 2b. A rotor (not shown) is disposed inside inner circumferential sections of the teeth 2b.

The coil 3 is wound around the teeth 2b of the stator core 2 and inserted into the slots 2c. The coil 3 is inserted through the slots 2c from the other side in the axial direction (a side below in FIG. 1) such that an end portion of the coil 3 is directed toward one side in the axial direction (a side above in FIG. 1) in a state in which the coil 3 has a plurality of U-shaped coils overlapping in the circumferential direction. After the coil 3 is inserted, the coil 3 is fixed to the stator core 2 through torsional bending of end portions of the coil 3 in the circumferential direction and coupling of the end portions. The coil 3 has a coil insertion section 4 inserted into the slots 2c, and an electric wire segment 5 protruding from an end surface of the stator core 2 toward one side in the axial direction.

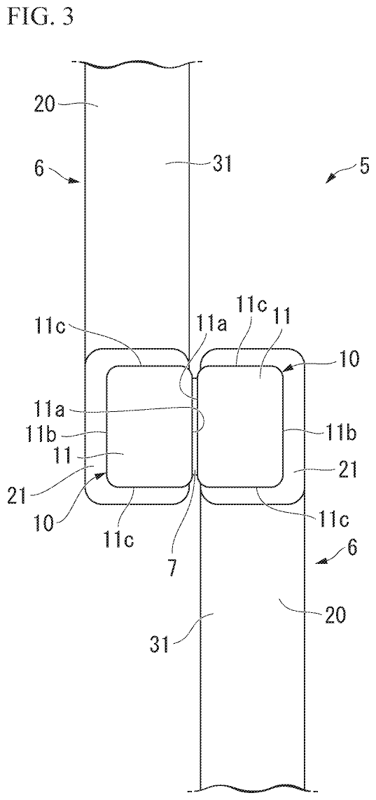

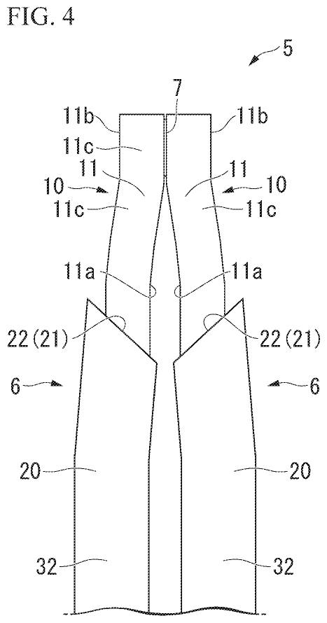

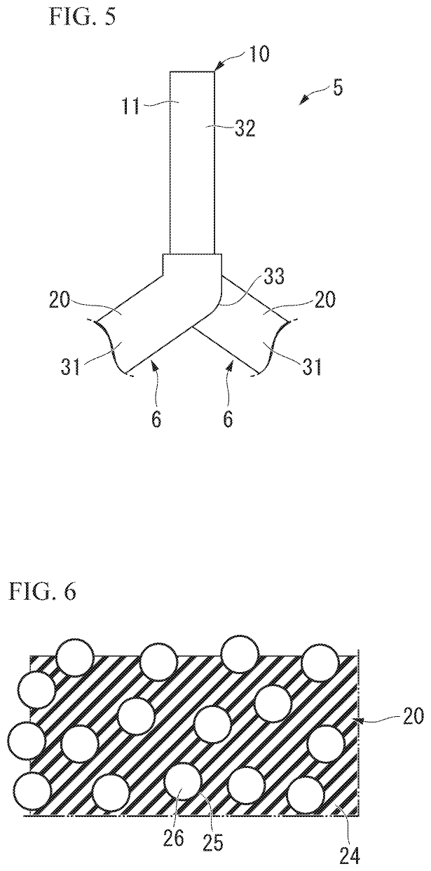

FIG. 3 is a view of the electric wire segment 5 when seen from one side in the axial direction. In addition, FIG. 4 is a view of the electric wire segment when seen in the circumferential direction, and FIG. 5 is a view of the electric wire segment when seen in the radial direction (a first direction).

As shown in FIG. 3, the electric wire segment 5 has a pair of electric wires 6 and 6 and a coupling section 7.

The electric wire 6 is a rectangular wire constituted by a conductive material 10 having a rectangular cross section, and an insulating film 20 configured to cover an outer circumferential section of the conductive material 10.

The electric wire 6 has an extending section 31, a tip portion 32 and a bent section 33 (see FIG. 5).

As shown in FIG. 2 and FIG. 5, the extension section 31 extends in the circumferential direction of the stator core 2. One end portion of the extension section 31 is connected to the coil insertion section 4 on an end surface on one side in the axial direction.

The tip portion 32 is connected to the other end portion of the extension section 31 and extends in the axial direction. The tip portions 32 and 32 of the pair of coupled electric wires 6 and 6 are arranged parallel to the radial direction (a first direction). As shown in FIG. 4, an insulating film end portion 21 is provided on the tip portion 32 in the electric wire 6.

The pair of electric wires 6 and 6 have exposed conductor sections 11 in which the insulating film 20 in the tip portion 32 is peeled off and the conductive material 10 is exposed, and the exposed conductor sections 11 and 11 are disposed at positions facing each other in the radial direction.

A peeling amount of the insulating film 20 on facing sides in the pair of electric wires 6 and 6 in the exposed conductor sections 11 is set to be larger than a peeling amount of the insulating film 20 on outward sides located opposite to the facing sides in the radial direction.

As shown in FIG. 3 and FIG. 4, the electric wire 6 has two side surfaces 11c and 11c provided in the radial direction, an outer surface 11b facing outward, and an inner surface 11a facing an facing side.

The insulating film 20 in the two side surfaces 11c and 11c of the electric wire 6 has an inclined section 22. The inclined section 22 connects the inner surface 11a and the outer surface 11b. The inclined section 22 is inclined from one side toward the other side in the axial direction as it goes from the outer surface 11b toward the inner surface 11a when seen in the circumferential direction. The inclined section 22 is formed so that an exposed area of the conductive material 10 is increased.

As shown in FIG. 2 and FIG. 5, the bent section 33 is provided between the extension section 31 and the tip portion 32. Due to the bent section 33, the pair of electric wires 6 and 6 are bent so that the electric wires 6 are separated from each other as the electric wires 6 go toward base ends from tip sides. The insulating film end portion 21 is formed on the tip side of the electric wire 6 with respect to the bent section 33.

Returning to FIG. 3, the coupling section 7 is provided on the inner surfaces 11a in the pair of electric wires 6 and 6.

The coupling section 7 physically and electrically connects the exposed conductor sections 11 and 11 in the pair of electric wires 6 and 6. In the embodiment, the exposed conductor sections 11 and 11 in the pair of electric wires 6 and 6 are coupled to each other through welding.

FIG. 6 is an enlarged cross-sectional view of the insulating film 20. The insulating film 20 has a vacancy 26 formed therein. The vacancy 26 is formed of a hollow capsule 25. Specifically, the insulating film 20 has a film main body 24 and the capsule 25.

The film main body 24 is formed of an insulating resin such as polyimide or the like. The film main body 24 has a plurality of hollow capsules 25 formed therein.

The capsule 25 is formed of a resin different from the film main body 24. The capsule 25 is, for example, a resin such as a silicone or the like. The capsule 25 is formed in a spherical shape. The inside of the capsule 25 becomes the vacancy 26.

The stator 1 is manufactured by a torsional bending process of torsionally bending the tip portions 32 of the pair of electric wires 6 and 6 in the circumferential direction, a coupling process of coupling the exposed conductor sections 11 and 11 to each other after the torsional bending process, and a coating process of performing powder coating on the exposed conductor section 11.

### (Actions and Effects)

Next, actions and effects of the electric wire segment 5 will be described.

According to the electric wire segment 5 of the configuration, since a peeling amount of the insulating film 20 in the inner surface 11a of the exposed conductor section 11 is larger than a peeling amount of the insulating film 20 in the outer surface 11b, contact between the insulating films 20 on the facing side of the pair of electric wires 6 and 6 can be minimized when the exposed conductor sections 11 are coupled. Accordingly, a distance between the pair of coupled electric wires 6 and 6 can be reduced. In addition, since the insulating film 20 of the inner surface 11a, which is sensitive to heat due to welding in comparison with the insulating film 20 of the outer surface 11b, can be disposed at a position separated from the coupling section 7, damage to the insulating film 20 due to heat during welding can be minimized.

Meanwhile, since a larger amount of the insulating film 20 is remained in the outer surface 11b facing of the other of the pair of electric wires 6 and 6 than the inner surface 11a, even when a distance between the pair of neighboring electric wires 6 and 6 is reduced, insulating properties between the pair of electric wires 6 and 6 can be highly maintained. In addition, since there is no need to perform a process of securing the distance between the pair of electric wires 6 and 6, the number of manufacturing processes and costs consumed for manufacture can be reduced.

Accordingly, it is possible to provide the small electric wire segment 5 in which the distance between the electric wires 6 and 6 is reduced while securing the insulating properties between the pair of neighboring electric wires 6 and 6.

In addition, since the electric wire 6 is constituted by a rectangular wire, the coupling section 7 can be formed on a portion of the pair of electric wires 6 and 6 to which the flat inner surface 11a face each other. Accordingly, a wide area of the coupling section 7 can be secured, and the conductive bodies 10 can be reliably coupled. In addition, it is possible to provide the electric wire segment 5 having high efficiency and an improved space factor of the coil 3 in the slots 2c.

In addition, since the insulating film 20 located at the side surface 11c of the electric wire 6 has the inclined section 22, a larger exposed area can be secured for the exposed conductor section 11 located at the facing side (on the side of the inner surface 11a) than for the exposed conductor section 11 located at the outward side (on the side of the outer surface 11b) due to the inclined section 22. Further, since the exposed area of the exposed conductor section 11 between the outer surface 11b and the inner surface 11a can be changed by simply cutting off the insulating film 20 obliquely, a time required for manufacturing can be minimized.

Accordingly, the exposed area of the exposed conductor section 11 can be changed through easy processing, and it is possible to provide the electric wire segment 5 in which insulating properties are able to be improved and a size thereof is able to be reduced.

In addition, the insulating film end portion 21 is present on the tip portion 32. Here, since the pair of electric wires 6 and 6 are arranged on the tip portion 32 in the radial direction, when the insulating film 20 is present on the tip portion 32, the insulating film 20 is disposed in the vicinity of the bent section 33 having a short distance between the other pair of electric wires 6 and 6, and insulating properties between the pair of neighboring electric wires 6 and 6 can be secured.

Accordingly, the distance between the pair of neighboring electric wires 6 and 6 can be reduced, and the electric wire segment 5 can be reduced in size in an arrangement direction.

In addition, since the insulating film 20 has the vacancy 26 formed therein and having permittivity lower than that of the film main body 24, permittivity of the insulating film 20 is reduced by the vacancy 26. Accordingly, when used as the insulating film 20 of the coil 3 used at a high voltage, occurrence of partial discharge in the insulating film 20 can be minimized. Accordingly, insulating performance of the insulating film 20 can be improved. In addition, since the vacancy 26 is formed of the hollow capsule 25, when a space surrounded by the capsule 25 is present in the insulating film 20, a thermal resistance of the entire insulating film 20 can be improved. Accordingly, the insulating film 20 having good thermal resistance and insulating properties and the electric wire segment 5 including the same can be provided.

According to the stator 1 of the configuration, it is possible to provide the stator 1 that is excellent and including the small electric wire segment 5 in which the distance between the electric wires 6 and 6 is reduced while securing insulating properties between the pair of neighboring electric wires 6 and 6.

### Second Embodiment

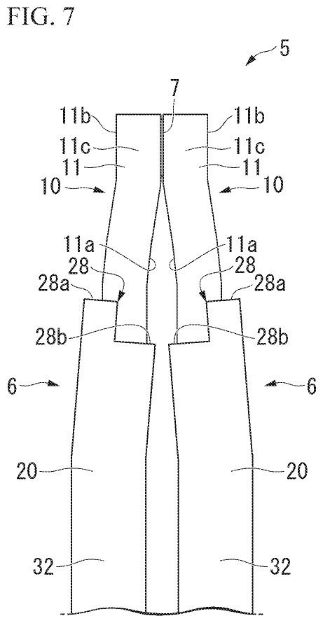

Next, a second embodiment according to the present invention will be described. FIG. 7 is a view of an electric wire segment according to the second embodiment when seen in a circumferential direction. The embodiment is distinguished from the above-mentioned embodiment in that the insulating film 20 has a step section 28.

In the following description, components the same as those in the above-mentioned first embodiment are designated by the same reference numerals and description thereof will be appropriately omitted. In addition, reference numerals related to components other than those disclosed in FIG. 7 will appropriately refer to FIG. 1 to FIG. 6.

As shown in FIG. 7, the insulating films 20 disposed on the two side surfaces 11c and 11c of the electric wires 6 have the step sections 28. The step sections 28 connect the inner surfaces 11a and the outer surfaces 11b. The step sections 28 is formed in a recessed shape from one side toward the other side in the axial direction when seen in the circumferential direction using first step sections 28a and second step sections 28b. The first step section 28a is formed to have the same height as that of the insulating film 20 in the outer surface 11b. The second step section 28b is formed to have the same height as that of the insulating film 20 in the inner surface 11a. The step section 28 is formed so that an exposed area of the conductive material 10 increases going from the outer surface 11b toward the inner surface 11a.

According to the second embodiment, in addition to the same actions and effects as those of the above-mentioned first embodiment being exhibited, in the torsional bending process of the electric wire segment 5, since the exposed conductor section 11 can be gripped deeply to an extent of a level difference of the step section 28, the electric wire segment 5 can be reliably torsionally bent.

Further, the technical scope of the present invention is not limited to the above-mentioned embodiments and various modifications may be made without departing from the scope of the present invention.

For example, the step section 28 may have three or more steps.

In addition, a cross-sectional shape of the conductive material 10 may be, for example, a circular shape, an elliptical shape, or the like, other than a rectangular shape.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. An electric wire segment comprising:
a pair of electric wires, the respective electric wires being arranged in a first direction and having an exposed conductor section in which a conductive material is exposed by having an insulating film peeled off at an end portion thereof, the exposed conductor sections of the respective electric wires being disposed at positions corresponding to each other; and
a coupling section in which the pair of electric wires are coupled to each other at the exposed conductor sections thereof,
wherein a peeling amount of the insulating films on facing sides of the exposed conductor sections in which the pair of electric wires face each other is larger than a peeling amount of the insulating films on outward sides of the exposed conductor sections which is opposite to the facing sides in the first direction.

2. The electric wire segment according to claim 1, wherein each of the pair of electric wires is a rectangular wire, the rectangular wire having two side surfaces provided along the first direction, an outward surface facing outward, and an inner surface facing the facing side.

3. The electric wire segment according to claim 2, wherein the insulating film on the two side surfaces of the electric wire has an inclined section formed so that an exposed area of the conductive material increases from the outer surface toward the inner surface.

4. The electric wire segment according to claim 2, wherein the insulating film on the two side surfaces of the electric wire has a step section formed such that an exposed area of the conductive material is increased from the outer surface toward the inner surface.

5. The electric wire segment according to claim 1, wherein the pair of electric wires have bent sections that are bent so that the electric wires are separated from each other as the electric wires go toward base ends from tip sides, and
an end portion of the insulating film is formed on the tip side of the electric wire with respect to the bent section.

6. The electric wire segment according to claim 1, wherein the insulating film has a vacancy formed therein, and
the vacancy is formed of a hollow capsule.

7. A stator comprising:
a stator core having a plurality of slots; and
a coil inserted into the slots and having the electric wire segment according to claim 1.
